(19) United States
(12) Patent Application Publication
(10) Pub. No.: US 2007/0245916 A1
(43) Pub. Date: Oct. 25, 2007

(54) Corrugated sheet fed printing process with UV curable inks

(75) Inventors: John W. Bird, Weston, CT (US); Warren K. Bird, Westport, CT (US); Peter D. Goeben, DePere, WI (US); Jack V. Roberts, Neenah, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: The Diagnostic Group, Neenah, WI (US)

(21) Appl. No.: 11/406,811

(22) Filed: Apr. 19, 2006

(51) Int. Cl. B41F 23/00

(52) U.S. Cl. 101/416.1

(57) ABSTRACT

A flexographic printing system for printing flat corrugated sheets using radiation curable inks. An ultraviolet curing unit is positioned after each of the printing stations. The ink applied at each station is partially cured before a different color ink is applied at the next printing station.

### BACKGROUND OF THE INVENTION

Corrugated paperboard has traditionally been used for the functional purpose of packaging goods in an inexpensive, sturdy container for transport and storage. The aesthetic value of the container was not considered as the container played no role in promoting the product therein to the purchaser. In more recent years, traditional methods of selling products have been changed to eliminate as many costs as possible. Stores have been rearranged to eliminate traditional warehouse shelving in back rooms; containers of products are now stacked throughout the store where consumers can select and purchase their choice of product with minimal assistance by costly store personnel. Corrugated containers which now play a vital role in advertising a product's features and benefits must have an aesthetic appeal to help differentiate one product from another. Consequently, methods for the aesthetic treatment of corrugated are being developed.

Stiff, heavyweight corrugated can only be continuously printed and/or coated on a straight line flexographic printing press since such thick sheets cannot be caused to wrap around and over plate cylinders or impression cylinders, as is common with flexographic presses which are used for printing flexible sheets and webs.

Flexographic straight-line printing machines traditionally are employed for the printing of relatively thick sheets of highly absorbent corrugated which move in a straight line, in flat condition, through one or more ink-printing stations. At each such station the thick, absorbent sheets pass in the nip between a flexographic plate cylinder and an impression or back-up cylinder, the raised images on the plate applying flexographic ink directly to the absorbent surface of each sheet. The flexographic ink comprises resin, pigment and volatile diluents and dries by the absorption of the diluent into the absorbent surface. This results in some spreading of the printed images, lines, etc., with resultant loss of sharpness, detail and quality of print. By manufacturing corrugated such that the printing surface is not highly absorbent, the printed image can remain crisp and detailed.

Modern printing processes used in the production of a variety of publication and packaging materials, including corrugated, typically use multiple colors to enhance the attractiveness and usability of the product. These processes commonly require high speed, sequential printing of several layers of variously colored ink, laying one on top of another to form still further colors, in order to achieve high production speeds and economic use of the equipment. Under these conditions, it is important to ensure that each subsequent layer of wet ink does not mix with preceding layers, thereby producing undesired color mixtures and diminishing the quality of the final product.

Prior art has addressed this problem by several different methods. The easiest method is to completely dry each layer of ink before applying the next layer. However, drying takes time and energy to accomplish, reducing productivity and increasing production costs.

Another method uses wet trapping. Wet trapping is a process whereby each successive ink layer is not fully dried prior to the application of the next layer. For this method to work it is important that each preceding layer adhere to its applied surface rather than the applicator of the successive layer. Prior art relies on the tack or the stickiness characteristics of each successive layer being less than the preceding layer.

In traditional offset lithographic printing, wet trapping relies on the viscosity and tack of the inks. The viscosities range in value from 20,000 to 100,000 cps and have a range of tack characteristics that permit wet trapping without any need for drying between color layers.

In recent years, flexographic printing has come into more common use for high quality, multicolor printing, particularly for various types of packaging products such as labels, bags, wraps, sleeves, folding cartons, displays, and corrugated containers. One advantage of this process is that a variety of substrate materials can be used to be printed on, including paper, film, foil, laminates, cardboard, and corrugated.

In flexography, an applicator and metering roll, known to the trade as an anilox roll, transfers ink from an ink containing pan or chamber to a printing plate roll. The anilox roll surface is covered with an array of ink receptor cells which receive ink as the roll is rotated through the liquid ink. Excess ink is metered off the anilox roll to leave a uniform layer of ink for transfer to the plate roll. The printing roll uses a compressible printing plate which has raised portions. These raised portions are coated with ink and pressed against the substrate to transfer the ink from the plate to the substrate. This process requires inks with lower viscosity than is used in the offset lithography process. The ink viscosities are typically less than 2,000 cps and are commonly less than 400 cps.

Flexographic inks generally are of two types: evaporative inks and energy curable inks. Further, those skilled in the art will understand that clear coatings and varnishes are un-pigmented inks commonly used for protection of the final printed surface against marring and scuffing, and are similar to pigmented inks in their chemistry. Therefore, the term “ink” will be used to include clear coatings and varnishes.

Evaporative inks use a transparent volatile vehicle to carry the colorant or pigment and binder or resin which binds the colorant to the substrate being printed, as well as provide other required functional properties of the finished product such as slip control, mar resistance, and printability control. The ink vehicle is composed of volatiles and a small amount of additives. The colorants and the binder are solids; therefore the primary role of the volatile, which can be either water or volatile organic chemicals, commonly known as solvents, is to put the ink into a fluid form capable of being printed. Once applied to the substrate, these inks solidify on the substrate through a drying process which evaporates the volatiles.

Energy curable inks, similar to evaporative inks, use colorants; however, unlike evaporative inks, the combined vehicle and binder are not volatile and the components remain on the substrate instead of some portion being evaporated. This ink is chemically transformed from a fluid to a solid through exposure to a concentrated beam of highly energized electrons or ultraviolet light. The tack of energy curable inks are very low and cannot be adequately measured with conventional instruments.

The above-described inks are commonly used in the flexographic printing industry. The choice of ink is determined in part by the end product being printed and in part by economics.

Evaporative solvent-based inks have been used on many products for many years but require costly special equipment and care in use due to their flammability. The evaporants from these inks also require costly, special equipment to either recover or destroy the volatile organic chemistry vapor rather than discharge it to the atmosphere where it has a recognized bad effect on air quality.

Evaporative water-based inks are being used increasingly to replace solvent-based inks. The use of water-based inks avoids the costs and problems associated with flammability and emission abatement. However, water generally requires more energy to evaporate than solvent. Also, water-based inks, by the nature of their chemistry, require care on the part of the press operator to maintain the proper levels of ink viscosity and pH.

During the printing operation, the ink is continually exposed to relatively dry, ambient air in ink reservoirs, chambers or trays, and on anilox rolls and plates, which promotes small amounts of evaporation of volatiles from the ink. As unused ink is continually recirculated through the ink application system, over time, the amount of volatiles in the ink are reduced. This changes the viscosity and pH values of the ink, thereby affecting the product quality and necessitating stopping the printing process to remove dried ink from plates and rollers, as well as restore the required viscosity and pH levels.

Energy curable inks, being non-volatile, do not require the costly equipment and care associated with the volatility of evaporative solvent inks, such as flammability, and emission abatement. Further advantages of energy curable inks are that on-press productivity can increase in that the press operator no longer needs to constantly monitor and adjust the ink chemistry to obtain the proper pH levels and viscosity values. Nor does the operator need to worry about cleaning the ink pumping system, ink pans or chambers, and anilox rolls during and between printing jobs. The ink does not solidify or harden until it is exposed to the appropriate energy sources.

The chemical transformation of energy curable inks is activated by exposure to either a beam of highly energized electrons as provided by electron beam (EB) equipment or ultraviolet (UV) light as provided by UV lamp equipment.

EB equipment requires the use of very high voltages to generate the necessary energy for accelerating the electrons. In addition to the danger posed by the required voltages, press operators and others must be shielded from the effects of the high energy electron beams; consequently, EB is large and expensive when compared with evaporative drying equipment and other energy curing equipment. It is used for special applications where product requirements dictate.

UV lamp equipment uses elongated, medium pressure, mercury vapor bulbs to provide the required levels of ultraviolet energy. The mercury vapor bulb is a sealed quartz tube that is pressurized and primarily contains a small bead of mercury and argon gas. When properly energized, the mercury becomes part of a plasma contained within the sealed quartz tube. This plasma is created either by a microwave generator or, as commonly used in flexographic printing, by an arc generated between electrodes located at each end of the bulb. Mercury bulbs produce peaks of energy at several specific wavelengths within the ultraviolet spectrum that energize photosensitive initiators that are included in the ink chemistry to start the required chemical transformation of the ink. The mercury in the bulbs can be further modified by the addition of small amounts of other materials such as gallium and iron to modify the ultraviolet spectral output of the bulbs and thereby give the ink manufacturer more options in producing easy-to-use and easy-to-cure inks. Many years of industrial experience with this technology has increased the effectiveness of this equipment and has reduced the cost. As an example, a two lamp system, each lamp consisting of a single bulb rated at between 400 and 600 watts per inch of arc length, will fully cure ultraviolet curable inks applied at production printing speeds of 750 to 1,200 feet per minute. Such a system can cost can cost between $1,000 and $2,000 per inch of maximum product width per print station. A comparable evaporative system for drying water-based inks can cost between twenty-five and fifty percent of the cost of a single or two lamp UV systems.

Further, UV lamp systems include a power supply that is capable of generating specially regulated voltages and currents suitable for use with the characteristics of the UV bulb. For flexographic printing, voltages can range from under 400 volts to over 2,000 volts, depending on the bulb arc length and the power required per inch of bulb length. Those skilled in the art know that the interaction between the bulb and the power supply require that each bulb have one power supply. In comparison, when drying water-based inks with an infrared heating dryer, multiple infrared bulbs can be powered by one inexpensive power supply, whereas UV energy curing systems must have one costly power supply for each bulb. Therefore, the UV equipment economics encourages the use of the fewest possible UV bulbs for the printed product width and production speed.

As commonly used, UV lamp systems make use of a single, elongated bulb oriented transverse to the direction of product travel through the printing press. For example, if the printed material is 60 inches wide, the UV lamp system will be equipped with a bulb that has an arc slightly longer than the printed material is wide. UV bulbs are commonly made with arc lengths of up to 80 inches. However, as the bulb length increases, bulb manufacturers have found that it becomes more and more difficult to maintain bulb straightness due to structural limitations of the quartz tube and the absorption of heat by the quartz material while operating. Where the width of the printed material is greater than the practical length of the UV bulb, additional bulbs are added to the system.

Prior art has suggested possible methods for wet trapping, low tack UV curable inks.

U.S. Pat. No. 4,070,497 refers to a topcoat applied over a series of coatings, each of which has been partially cured with ultraviolet light and which then is finally cured by an electron beam. In the preferred embodiment of this invention, the substrate material is metal, but materials such as wood, paper, and plastic are cited. The cited dwell time for curing each coating is 0.1 to 2.0 seconds. Each intermediate coating layer is partially cured to prevent the successive coating layers from running into or mixing with each other. The cited processing speeds are 15 feet per minute.

U.S. Pat. No. 5,407,708 describes a system and method for printing food packaging plastic film substrates, including heat shrinking substrates, using a combination of UV radiation and EB radiation. The flexographic printing system cited employs a common central impression cylinder for supporting the substrate as it is printed in multiple stations around the central impression cylinder. As each ink layer is applied, it is partially cured, sufficient to allow the next ink layer to be applied without pick-off or smearing of the previous layer. The final curing is accomplished by use of an electron beam generator which completes the cure while bonding the inks to the food packaging substrate. The advantages cited refer, among others, to the reduction in required amounts of photoinitiators, the completion of the photochemical reaction (curing) to eliminate odor and taint of packaged food, and the reduction of heat applied to the heat shrinkable substrate. The invention cites inks with photoinitiator contents of 10% or less and UV radiation input of 300 watts per inch or less.

U.S. Pat. No. 5,562,951 describes a method for decorating an article printed with separate radiation curable inks, without completely curing each ink prior to application of the next ink. After all the inks have been applied, the article is subjected to a cure dwell time sufficient to affect a complete cure of all the applied inks. The preferred embodiment refers to articles of glass or ceramic used to contain cosmetics or beverages. The ink application method suggested is screen printing, gravure printing, hand application, and the like. In order to affect a partial cure, the inventor lists an optimum radiation intensity of 15 mj/cm² to 20,000 mj/cm² and cure dwell time of 0.05 seconds to 5 seconds at room temperature.

In U.S. Pat. No. 5,690,028 a continuous substrate is fed around a central impression cylinder which rotates so that the substrate successively passes through a plurality of inking stations. When passing through each ink station, ink is heated to a predetermined temperature that is higher than the temperature of the central impression cylinder wherein the viscosity of the ink is dropped low enough so that the ink may be transferred to the cool substrate causing the temperature of the ink to drop and the viscosity to climb. This allows previous down inks to have a higher viscosity than the ink applied at the succeeding station. Finally, after all the layers of ink are applied, the ink is fully cured at a final curing station. This method requires substantial modification of the printing press equipment to maintain the appropriate temperature throughout the ink circulating system at each print station. Furthermore, it may be necessary to apply cooling to the substrate or reduce the press speed in order to maintain ink temperatures at levels that do not adversely affect the ink.

U.S. Pat. No. 6,772,683 uses a method also suited for use on a central impression press with sequential ink application stations. The energy curable ink vehicle, in addition to containing the normal photosensitive initiators, contains a non-reactive, evaporative diluent. After the ink is applied to the substrate, the non-reactive diluent is evaporated, thereby raising the viscosity of the ink. Subsequent applications of ink are similar so that a low viscosity ink is always applied to a higher viscosity surface. Again, after all the layers of ink are applied, the ink is fully cured at a final curing station. This method requires equipping the press with some type of dryer between each print station. Also, this method requires the manufacture of special inks that contain both energy curable and evaporative constituents, thereby reducing the general availability and increasing the cost. Finally, the use of evaporative constituents requires that the press operator continually monitor and adjust the ink viscosity throughout the press run, thereby increasing the production cost.

This prior art has disadvantages for the present requirements of printing energy curable inks on corrugated material using commonly available, straight line flexographic printing presses. These printing presses can produce multiple color printed and die cut sheets, ready to be folded into containers, at production rates of up to 11,000 sheets per hour. As each sheet on these commonly available presses can be as long as 66 inches in the sheet transport direction, it is a simple calculation to determine that the corrugated surface speed through the press can be as high as 1,008 feet per minute. (11,000 sheets or revolution of the print cylinder per hour times 66 inches per revolution of the print cylinder divided by 12 feet per inch divided by 60 minutes per hour equals 1,008 feet per minute).

In addition, commonly available and traditional presses used for straight line corrugated printing, are known as “close-coupled machines” or “mobile printing unit machines”. These close-coupled machines are characterized by two features: 1) the corrugated material is printed on the bottom of the sheet so as to locate the large, heavy, fast rotating printing plate cylinder and other associated ink transport equipment close to the floor where it is structurally more rigid and where it is more accessible by press operators, and 2) by having very little distance between the centerlines of each successive print station. These distances commonly range between 24 inches and 35 inches. Consequently, with a 66 inch circumference print cylinder taking up most of this available space, there is very little room for installing equipment to cure energy curable inks between successive print cylinders. Depending on the press configuration, approximately nine to eighteen inches in the sheet transport direction and up to twelve inches of vertical distance is available. For this reason, only some form of UV lamp system is suitable for location between print units on these presses when used with energy curable inks.

Further, these machines are made with a sheet transporting system that keeps the corrugated material traveling a straight line path as it moves through the machine from print station to print station, especially when the corrugated material being printed is shorter than the center to center spacing of each successive print station. The sheet transporting system, known in the trade as a “vacuum transport system” is unique to each press manufacturer but all such systems share a common method, i.e. vacuum pressure holds the top of the corrugated material against rollers, belts, or pulleys which move at a surface speed that matches the production speed of the press and transports the corrugated material from print station to print station, passing over a dryer for evaporative inks or a UV lamp used for energy curable inks.

Those skilled in the art will appreciate that these rotary components must maintain proper alignment one with another and with the rest of the machine and must always rotate at the required speed in order for the machine to produce quality printed sheets. If these rotary components and their support structure get too hot, it can also be appreciated that a variety of thermal effects may adversely affect the continuing proper operation of these parts.

Yet further, those skilled in the art of direct flexographic corrugated printing are familiar with the results of studies done by the Technical Association of the Pulp and Paper Industry (TAPPI) and other trade groups that have led to a “rule of thumb” that 80 percent of press operation is used for printing corrugated sheets that are less than 50 percent of the maximum printable width of the press. Therefore, the use of evaporative dryers or UV lamps with direct exposure to the vacuum transfer system is potentially a source of disruptive maintenance if the heat from these devices is not limited by some method.

Prior art dryers use both hot air convection methods and infrared radiation methods for drying evaporative inks, but infrared radiation dryers are generally preferred due to their higher heat transfer efficiency and their ability to be selectively activated across the width of the machine so that the required heat is applied only to the width of corrugated material surface being printed and not to the areas of the vacuum transfer system where no corrugated material is shielding the vacuum transfer plate and rotary components from direct exposure to the infrared radiation.

As noted previously in this background description, the economic manufacture of UV lamp systems encourages the use of long bulbs that under many operating circumstances will exceed the width of the corrugated material. In addition, high intensity UV bulbs radiate about 50 percent of their energy as infrared energy which, in these same circumstances, results in continual direct exposure of the vacuum transfer system to this heat. Prior art UV lamp systems are employed in web fed presses such as those using cooled central impression cylinders or cooled rollers where directly applied heat is removed or those where the location of the UV lamp system is not directly exposed to complex transport mechanisms critical to obtaining quality printed product.

Finally, prior art devices have the disadvantage of high cost. In order to be generally affordable for corrugated container printers, the capital cost of the UV lamp equipment should be competitive with currently available evaporative drying equipment costs.

Naturally, it would be highly desirable to provide a system and method for multiple color printing and die-cutting of corrugated materials in one pass of materials through the press, and more particularly, for providing such a system and method that is compatible with the cost and use of evaporative ink drying equipment.

### BRIEF SUMMARY OF THE INVENTION

In accordance with the present invention, a system is provided for partially curing radiation curable inks to a substrate at successive printing stations. The system comprises a first print station having means for applying a first application of a radiation curable ink to a substrate, an ultraviolet radiation means downstream of the first print station for partially curing the first layer of ink on the substrate so as to prevent pick-off and smearing at a subsequent print station, a series of subsequent print stations downstream from the first station UV radiation means, each with a means for applying radiation curable inks to the substrate, each subsequent application station with a UV radiation means downstream of the print station for partially curing each successive applied ink layer, except for the last station which uses a UV radiation means to finally cure all preceding ink layers.

In a preferred embodiment of the present invention, the system is a flexographic printing system used for printing flat, thick, heavy absorbent and non-absorbent sheets in a straight line path through the press and able to run at surface speeds of 1,000 feet per minute. The UV radiation means is located between adjacent print stations for partially curing the ink applied at the preceding station. The input of each radiation curing means used for partially curing the ink is preferably less than 200 watts per inch of sheet width.

### BRIEF DESCRIPTION OF THE DRAWINGS

FIG. 1 is a schematic side elevation section view of a representative in-line corrugated printing press having a plurality of laterally spaced printing stations and inter-station UV curing systems constructed in accordance with this invention.

FIGS. 2A and 2B are top and cross-sectional views, respectively of the UV curing head assembly of the inter-station UV curing system.

FIG. 3 is a cross-sectional view of the inter-station UV curing system along section 3-3 of FIG. 2A.

### DETAILED DESCRIPTION

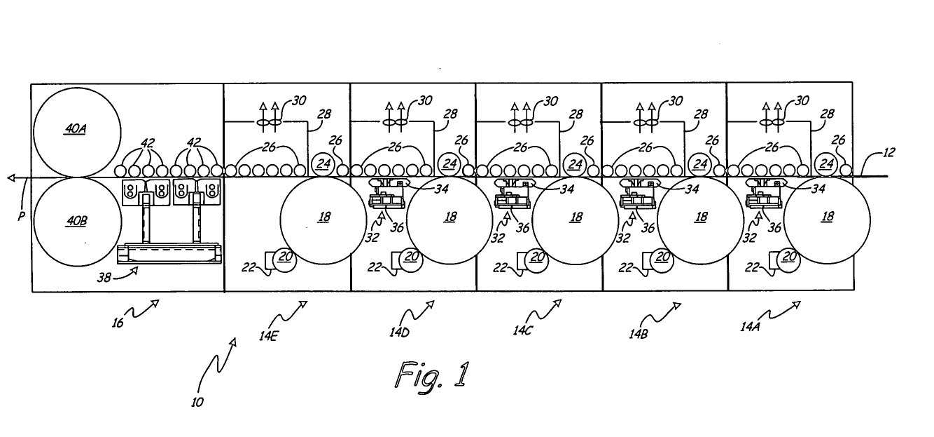

FIG. 1 shows flexographic printing press 10 for printing on flat sheets 12 of corrugated material as sheets 12 travel along linear path P through press 10. Press 10 includes printing stations 14A-14E, and final curing/die cutting station 16.

Each printing station 14A-14E includes rotary plate cylinder 18, metering anilox roll 20, ink chamber 22, impression roll 24, transfer rollers 26, vacuum chamber 28, and exhaust fan 30.

Attached to each rotary plate cylinder 18 is a flexible, raised-surface printing plate. Metering anilox roll 20 applies ink to the plate, and ink chamber 22 applies ink to anilox roll 20. Impression roll 24 supports sheet 12 when the raised print surface of the printing plate is pressed against the printed corrugated material.

Transfer rollers 26 are part of each print station and are arranged between impression rollers 24. Most, if not all, of transfer rollers 26 are contained within a closed, vacuum transfer chambers 28. Exhaust fan 30 is used to pull air from vacuum transfer chamber 28, through whatever openings are available, including from between transfer rollers 26. When sheet 12 of corrugated material is passed through press 10 for printing, sheet 12 requires support where it is not captured by the nip between the printing plate on cylinder 18 and impression cylinder 24. The vacuum within vacuum chamber 28 pulls sheet 12 against transport rollers 26 while the driven rotation of transport rollers 26 moves sheet 12 toward the next print station, thereby maintaining sheet speed and direction to ensure proper print registration.

Ink is transferred to the bottom side of sheet 12 from the printing plate. Each print station 14A-14E applies a different color of ink. In order to keep each succeeding ink from mixing with the previously applied ink, each of print stations 14A-14D includes inter-station UV curing unit 32, which is located after each print application point to partially cure the “wet” ink before the next color is applied. Inter-station UV curing unit 32 includes UV curing head assembly 34 and fan duct assembly 36. Depending on the width of sheets to be printed, UV curing head assembly 34 includes one or more UV lamp subassemblies.

Final curing and die cutting station 16 includes final UV curing unit 38, die cutting rollers 40A and 40B, and transfer rollers 42. After the final application of ink at print station 14E, sheet 12 is transported by rollers 26 and 42 past final UV curing unit 38, where UV energy sufficient to complete curing of the layers of ink is directed onto the ink on the bottom surface of sheet 12. Following the final curing, sheet 12 is fed through die cutting rollers 40A and 40B and then exits press 10.

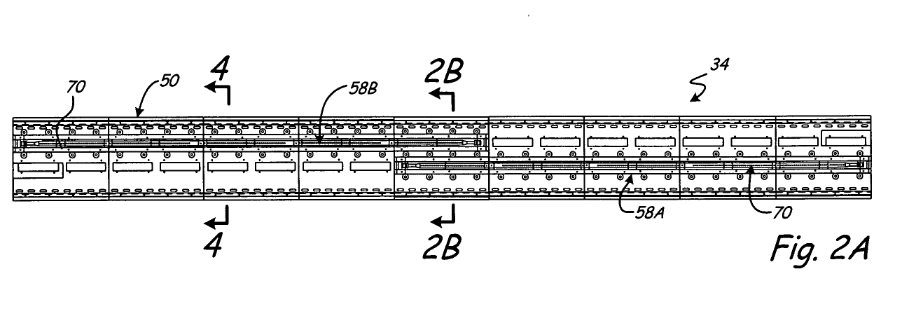

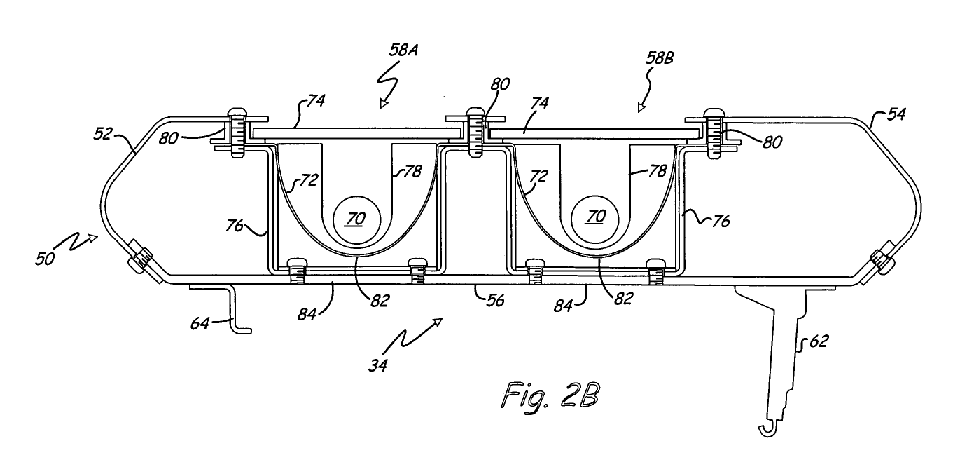

FIGS. 2A and 2B show UV curing head assembly 34, which includes housing 50 (formed by covers 52 and 54 and base plate 56), UV lamp subassemblies 58A and 58B, terminal blocks 60, latch 62 and mounting guide 64. Each lamp subassembly 58A, 58B includes UV lamp 70, reflector 72, quartz glass cover 74, side support 76, lamp holder 78, and spacer 80. UV lamp 70 is preferably a commonly available, medium pressure, mercury vapor lamp, rated at about 150 watts per inch or less, and preferably about 100 watts per inch or less.

Reflectors 72 are made from thin aluminum sheet metal, preferably coated with a dichroic coating to reflect ultraviolet energy but absorb infrared energy. The reflector shape is preferentially a section of an ellipse, designed in conjunction with the position of UV lamp 70 to reflect a uniform application of ultraviolet energy on to corrugated sheet 12 as it passes.

Several sections of reflector 72 are spaced continuously and uniformly along the length of UV lamp 70. The length of the sections are designed to eliminate thermal distortion of reflector 72. Further, a series of small diameter holes 82 are located at the bottom of reflector 72 and are closely spaced along the axis of UV lamp 70. These permit cooling air from the fan duct assembly 36 to flow through the holes 82 and onto UV lamp 70.

With many corrugated printing press installations, there can be a significant amount of paper dust and debris in the air. The source of this dust and debris can be from the corrugated sheets or from a die-cutting process (rollers 40A and 40B) that is frequently incorporated into the end of the printing press (as shown in FIG. 1). This rotary die-cutting process is used to cut out the appropriate sections of the rectangular sheet of printed corrugated material to form the box or display. As this process cuts through the corrugated material, a significant amount of dust is generated. Also, small slots may be cut out of the material and the cutout portions are flung widely through the rotary action of the die cutter rollers 40A and 40B. In order to prevent dust and debris from building up in close proximity to high temperature lamps, the lamps and other hot parts must be isolated. Quartz glass cover 74, in conjunction with the airflow, shields UV lamp 70 and reflector cavity 72.

Side supports 76 provide the structure to hold the reflector 72 sections and quartz glass covers 74, as well as guide cooling airflow along the outside of the reflector sections. UV lamp 70, at each end, is held in a cradle-like holder.

UV lamp subassemblies 58A, 58B are attached to base plate 56, which contains holes 84 that permit air from fan duct assembly 36 to enter UV lamp subassemblies 58A and 58B. Covers 52 and 54 are used to guide air movement, capture quartz glass covers 74, contain terminal blocks 60 and form a wireway for power and control wiring.

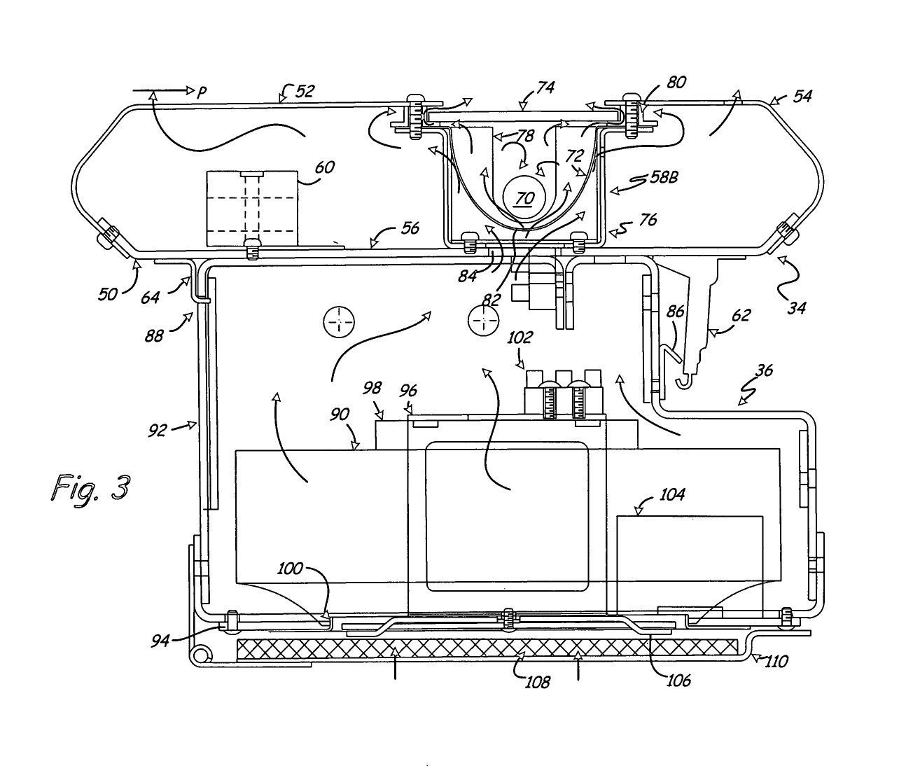

FIG. 3 shows a cross-section (along section 3-3 of FIG. 2A) of inter-station UV curing unit 32 which includes the fan duct assembly 36 and the UV curing head assembly 34. UV curing head assembly 34 is detachable from fan duct assembly 36. Latch 62 of assembly 34 and catch 86 of assembly 36 are used in conjunction with a mounting guide 64 of assembly 34, and mounting hole 88 of assembly 36 to position UV curing head 34 on fan duct assembly 36 and secure it in place.

As shown in FIG. 3, fan duct assembly 36 includes several fan subassemblies 90 spaced apart and located within duct housing 92. Fan subassembly also includes mounting plate 94, fan mounting bracket 96, motorized impeller 98, air inlet ring 100, terminal block 102, motor capacitor 104, and finger guard 106. Motorized impellers are commonly available and use a backward inclined centrifugal fan wheel that is integrated with a motor to provide high volume, high pressure air movement in a confined space. Replaceable filter media 108 is placed between fan mounting plate 94 and hinged filter holder 110. Paper dust and other debris is generally present within the press and the filter media reduces the amount that is able to enter fan duct assembly 36 and UV curing head assembly 34. By opening hinged filter holder 110, the filter media 108 can be removed for cleaning or replacing. Fan duct assembly 36 also acts as a wireway for containing wires used in powering and controlling UV curing unit 32. Airflow paths through fan duct assembly 36, and UV curing head assembly 34 are represented by arrows in FIG. 3.

The present invention provides a system for curing radiation curable inks applied to relatively thick sheets of absorbent and non-absorbent corrugated which move at high speed in a straight line, in flat condition, through one or more ink-printing stations. The system partially cures each applied layer of radiation curable ink to allow “wet” trapping of the ink and a final, complete cure of all the ink layers. The use of low power UV lamps provides a system which has minimal thermal effect on the printing press. The system has a capital cost comparable to prior art evaporative ink drying systems.

The ability to use UV curable inks to print corrugated sheets increases the ratio of productive time divided by operating time by eliminating the amount of press stoppage time required to adjust the ink chemistry, clean printing plates and clean other printing surfaces. These types of press stoppage time have been common with water-based evaporative ink printing presses used for printing corrugated sheets.

Although the present invention has been described with reference to preferred embodiments, workers skilled in the art will recognize that changes may be made in form and detail without departing from the spirit and scope of the invention. For example, although UV curing head assembly 34 has been shown with two staggered UV lamp subassemblies 58A, 58B other configurations having only one UV lamp or having three or more UV lamps may be used, depending upon the width of the sheets being printed.

1. A printing system for printing corrugated sheets using radiation curable inks, the system comprising:
a transport system for transporting corrugated sheets along a linear path;
a series of printing stations for successively applying layers of radiation curable ink to sheets;
a series of interstation UV radiation sources for partially curing layers of radiation curable ink; and
a final UV radiation source following a last printing station of the series for curing all preceding layers of radiation curable ink.

2. The system of claim 1, wherein the printing stations are positioned to apply ink to a bottom surface of the sheets, and the interstation UV radiation sources and the final UV radiation source are positioned to direct UV radiation at the bottom surface of the sheets.

3. The system of claim 1 wherein the interstation UV radiation sources each include at least one elongated UV lamp.

4. The system of claim 3, wherein the UV lamp comprises a medium pressure mercury vapor lamp.

5. The system of claim 3, wherein the UV lamp has a rating of about 150 watts per inch or less.

6. The system of claim 5, wherein the UV lamp has a rating of about 100 watts per inch or less.

7. The system of claim 3, wherein the interstation UV radiation sources each include at least two UV lamps.

8. The system of claim 1, wherein each of the interstation UV radiation sources includes a fan duct assembly and a UV curing head assembly mounted on the fan duct assembly.

9. The system of claim 8, wherein the fan duct assembly directs air flow through the UV curing head.

10. The system of claim 9, wherein the UV curing head includes at least one elongated UV lamp having a rating of about 150 watts per inch or less.

11. The system of claim 10, wherein the UV lamp has a rating of about 100 watts per inch or less.

12. The system of claim 1, wherein the transport system is capable of transporting sheets at surface speeds of up to at least 1,000 feet per minute.

13. A method of printing flat corrugated sheets, the method comprising:
applying a first layer of radiation curable ink to a flat sheet;
partially curing the first layer with UV radiation;
applying a second layer of radiation curable ink to the flat sheet; and
at least partially curing the second layer with UV radiation.

14. The method of claim 13, wherein the first and second layers are applied to a bottom surface of the flat sheet, and wherein partially curing the first layer comprises directing UV radiation onto the first layer of radiation curable ink on the bottom surface.

15. The method of claim 13, wherein the UV radiation for partially curing is produced by one or more UV lamps having a rating of about 150 watts per inch or less.

16. The method of claim 15, wherein the UV lamps have a rating of about 100 watts per inch or less.

17. A corrugated sheet fed printing process comprising:
transporting corrugated sheets along a linear path past a plurality of printing stations;
applying a layer of UV curable ink to the sheets at each printing station; and
partially curing the layers of UV curable ink between successive printing stations with UV radiation.

18. The method of claim 17, wherein the UV radiation for partially curing is supplied by a UV source having a rating of about 150 watts per inch or less.

19. The method of claim 18, wherein the UV source has a rating of about 100 watts per inch or less.

20. The method of claim 17 and further comprising:
finally curing the layers of ink with UV radiation following application of ink by a final printing station of the plurality of printing stations.
